(19) United States
(12) Patent Application Publication
(10) Pub. No.: US 2015/0330478 A1
(43) Pub. Date: Nov. 19, 2015

(54) Cable management member

(71) Applicant: Beats Electronics, LLC, Culver City, CA (US)

(72) Inventor: Tijender Singh Grewal, Pacific Palisades, CA (US)

(73) Assignee: Beats Electronics, LLC, Culver City, CA (US)

(21) Appl. No.: 14/120,277

(22) Filed: May 14, 2014

(51) Int. Cl. F16G 11/14; H04R 1/10

(52) U.S. Cl. CPC F16G 11/14; H04R 1/1033

(57) ABSTRACT

A cable management member is disclosed for controlling the adjustment of a cable portion received through the cable management member. The cable management member may be part of a headphone system that includes an earpiece unit, a cable portion, an input control portion, and the cable management member.

### BACKGROUND

Cable management is a field that may be populated with different types of solutions based on, among other potential factors, the physical characteristics of the cable being managed or the intended goals for the cable management.

It follows that the following disclosure describes a cable management member designed and configured to meet the goals of cable management described throughout this disclosure.

### SUMMARY

This application is defined by the appended claims. The description summarizes aspects of the embodiments and should not be used to limit the claims. Other implementations are contemplated in accordance with the techniques described herein, as will be apparent upon examination of the following drawings and detailed description, and such implementations are intended to be within the scope of this application.

This disclosure generally relates to a cable management member configured to control the adjustment of a cable portion. Exemplary embodiments provide a cable management member configured to control a length of cable that is received through the cable management member. In exemplary embodiments, the cable received by the wire adjustment member may have the physical characteristic of being flat, or at least substantially flat, on at least two opposing sides. Further, in exemplary embodiments the cable received by the cable management member may be a single portion of wire that is received through the wire adjustment member.

According to some embodiments, a cable management member is disclosed that comprises a main piece. The main piece may include a first opening for receiving a first cable portion; a second opening for receiving a second cable portion; a first side opening that opens up around a portion of a periphery of the main piece, and a second side opening that opens up around a portion of a periphery of the main piece opposite the first side opening.

According to some embodiments, a headphone system is disclosed that comprises an earpiece unit comprised of a first earpiece and a second earpiece, the earpiece unit further including a wireless interface configured to receive an audio data transmission; a cable portion configured to connect the first earpiece and the second earpiece, and a cable management member including a first opening and a second opening for receiving the cable portion through the cable management member.

### BRIEF DESCRIPTION OF THE DRAWINGS

For a better understanding of the invention, reference may be made to embodiments shown in the following drawings. The components in the drawings are not necessarily to scale and related elements may be omitted so as to emphasize and clearly illustrate the novel features described herein. In addition, system components can be variously arranged, as known in the art. In the figures, like referenced numerals may refer to like parts throughout the different figures unless otherwise specified.

FIG. 1 illustrates an exemplary headphone system without a cable management member included;

FIG. 2 illustrates an exemplary headphone system with the cable management member included;

FIG. 3 illustrates an exemplary angled perspective view of the cable management member;

FIG. 4 illustrates an exemplary front perspective view of the cable management member, an exemplary side perspective view of the cable management member, an exemplary back perspective view of the cable management member, an exemplary bottom perspective view of the cable management member, and an exemplary cross-sectional view of the cable management member;

FIG. 5 illustrates an exemplary front perspective view of the cable management member, an exemplary side perspective view of the cable management member, an exemplary back perspective view of the cable management member, and an exemplary cross-sectional view of the cable management member that further identifies exemplary proportional size ratios for features of the cable management member;

FIG. 6 illustrates an exemplary headphone system with the cable management member included.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated. Not all of the depicted components described in this disclosure may be required, however, and some implementations may include additional, different, or fewer components from those expressly described in this disclosure. Variations in the arrangement and type of the components may be made without departing from the spirit or scope of the claims as set forth herein.

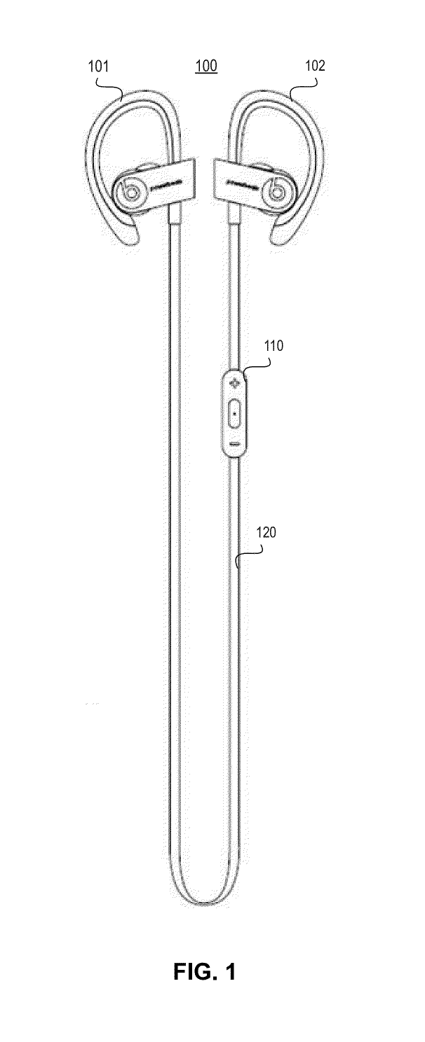

The present disclosure describes a cable management member that is configured to manage the adjustment of a cable portion running through it. The cable portion may, for example, correspond to the cable portion 120 illustrated in FIG. 1 according to some embodiments described herein. The cable portion 120 illustrated in FIG. 1 is seen to have at least two opposing sides that are flat, or substantially flat, when viewed from a cross-sectional view taken along a length of the cable portion 120.

FIG. 1 further illustrates a headphone system 100 that includes a first earpiece 101, a second earpiece 102, and an input control portion 110. The headphone system 100 may be in communication with a media device (e.g., smartphone, music player, music server, or other device capable of transmitting a digital music signal to the headphone system 100) in order to receive digital music data to be output by the first earpiece 101 and/or second earpiece 102.

The first earpiece 101 and second earpiece 102 together may comprise a wireless earpiece unit configured to include an interface for receiving a data signal including music data, other sound data, and/or control data for controlling operation of the headphone system 100 from a media device. For example, the interface may be configured to be within the first earpiece 101, second earpiece 102, or to have portions within both the first earpiece 101 and second earpiece 102. Alternatively, in some embodiments the input control portion 110 may include an interface for receiving the data signal from the media device. The data signal received by the interface according to any of the embodiments may be a data signal in accordance to any one or more wireless data transfer protocols, including, but not limited to, Bluetooth, near frequency communication (NFC), WiFi, or other similar wireless data transfer protocol capable of transmitting a data signal that includes at least digital music data.

The input control portion 110 may be attached to the cable portion 120, and allow for at least two control inputs for increasing the volume of audio data output from the first earpiece 101 and/or second earpiece 102, and decreasing the volume of audio data output from the first earpiece 101 and/or second earpiece 102. In addition, the input control portion 110 may also be configured to receive addition control inputs for controlling the operation of the media device in communication with the headphone system 100. The received control inputs may be transmitted to the media device via the interface included in the first earpiece 101 and/or second earpiece 102. Alternatively, in some embodiments the input control portion 110 may also have an interface similar to the interface included in the first earpiece 101 and/or second earpiece 102, such that the control inputs may be transmitted directly from the interface of the input control portion 110 to the media device.

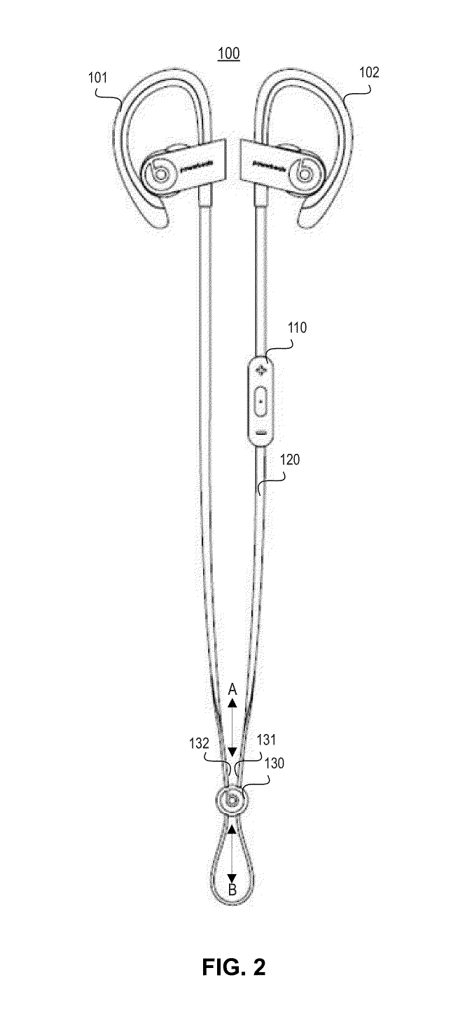

The cable portion 120 may be of a type to have two flat, or substantially flat, opposing sides. The cable portion 120 may be comprised of a soft polymer coating that allows for the cable portion 120 to be flexible yet maintain its form, water resistant, and allow for varying degrees of adhesive or frictional properties when come into contact with the cable management member illustrated in FIG. 2. For example, the coating may be a type of thermoplastic polyurethane (TPU), plastic, rubber, or other polymer having similar characteristics thereof. The cable portion 120 may also be comprised of wiring within the coating. The wiring may be made of a material (e.g., copper) having conductive properties for communicating audio, control, and/or other types of informational data between one or more components of the headphone system 100.

FIG. 1 is provided to illustrate the headphone system 100 in a state without the cable management member. The headphone system 100 is illustrated to show the cable portion 120 as a single cable connecting the first earpiece 101 and the second earpiece 102. The cable portion 120 is able to be comprised of the single cable because the first earpiece 101 and second earpiece 102 are part of a wireless earpiece unit, as described above. In other words, the cable portion 120 does not specifically require a separate cable portion for including a connection portion (e.g., audio input jack) for physical connection with the media device. This way, the headphone system 100 is able to communicate with the media device without the requirement for a physical connection to the media device. One of the benefits of the wireless communications capabilities of the headphone system 100 is the ability to have the streamlined cable portion 120 comprised of the single length piece. This is in contrast to the ‘Y’ shaped configurations of other headphone systems that do not have the wireless communications capabilities, and therefore require one end of a cable portion to include a connection portion (e.g., audio input jack) while the remaining two ends are connected to earpiece portions.

FIG. 2 illustrates the headphone system 100 with the cable management member 130 included. The cable management member 130 is configured to accept the cable portion 120 through two openings, the first opening 131 and second opening 132. By allowing the cable portion 120 to move through the first opening 131 and second opening 132 of the cable management member 130, the cable management member 130 may be adjusted up and down the cable portion 120. Moving the cable management member 130 up may shorten a length of the cable portion 120 that is above (A) the cable management member 130 while increasing a length of the cable portion 120 that is below (B) the cable management member 130. Conversely, moving the cable management member 130 down may increase a length of the cable portion 120 that is above (A) the cable management member 130 while shortening a length of the cable portion 120 that is below (B) the cable management member. In this way, the cable management member 130 is capable of providing a user wearing the headphone system with adjustment of the cable portion 120.

For example, by sliding the cable management member 130 up as described above, the headphone system 100 may be adjusted to fit tighter around a head of the user wearing the headphone system 100. Similarly, by sliding the cable management member 130 down as described above, the headphone system may be adjusted to fit looser around a head of the user wearing the headphone system 100. Further description is provided below.

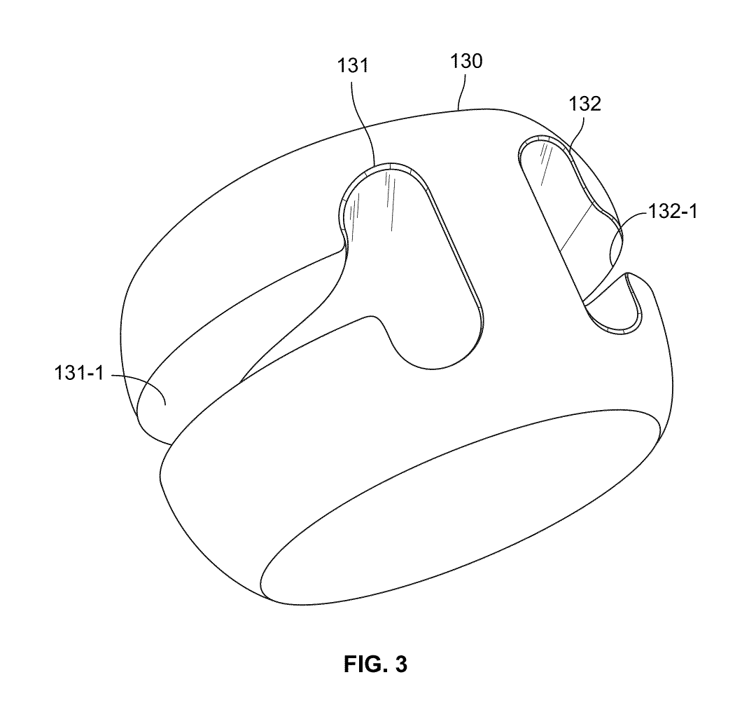

FIG. 3 illustrates an angled perspective view of the cable management member 130 that provides a clearer view into the first opening 131 and the second opening 132.

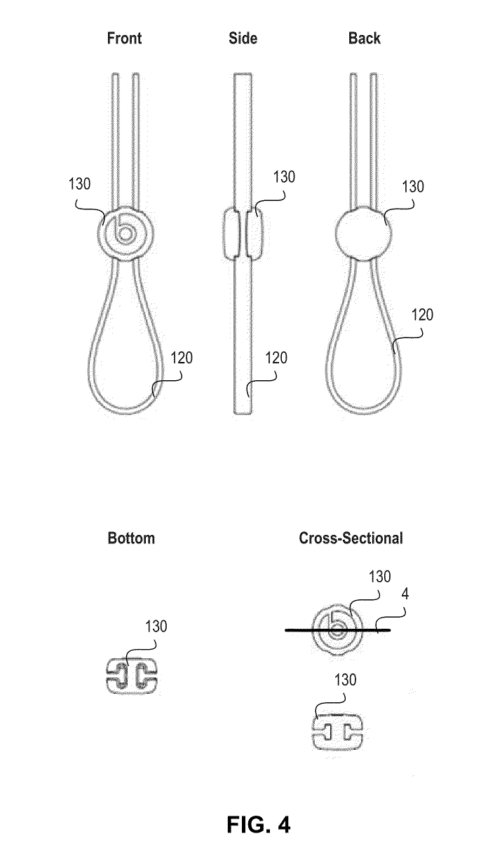

The first opening 131 is shaped to receive the cable portion 120 that slides through it. It follows that the first opening 131 may be comprised of a top opening (illustrated), a channel (partially illustrated) through the cable management member 130 through which the cable portion 120 travels through, and a bottom opening (not illustrated) that opens out through the bottom of the cable management member 130. The shape of the top opening, channel, and bottom opening of the first opening 131 may be consistent throughout in order to effectively match the shape of the cable portion 120 being received through it. For example, this is illustrated by the exemplary bottom perspective view provided in FIG. 4. The size of the first opening 131 may be the same, or slightly larger, as the size of the cable portion 120 received through it.

Similarly, the second opening 132 is shaped to receive the cable portion 120 that slides through it. It follows that the second opening 132 may be comprised of a top opening (illustrated), a channel (partially illustrated) through the cable management member 130 through which the cable portion 120 travels though, and a bottom opening (not illustrated) that opens out through the bottom of the cable management member 130. The shape, of the top opening, channel, and bottom opening of the second opening 132 may be consistent throughout in order to effectively match the shape of the cable portion 120 being received through it. For example, this is illustrated by the exemplary bottom perspective view provided in FIG. 4. The size of the second opening 132 may be the same, or slightly larger, as the size of the cable portion 120 received through it.

Further, in some embodiments as illustrated in FIG. 3, the cable management member 130 may include side openings 131-1 and 132-1 that are positioned to be substantially opposite from each other on the periphery sides of the cable management member 130. Side opening 131-1 may extend from the top opening of the first opening 131 to the bottom opening of the first opening 131, while also extending from the periphery of the cable management member 130 and into the channel portion of the first opening 131. Side opening 132-1 may extend from the top opening of the second opening 132 to the bottom opening of the second opening 132, while also extending from the periphery of the cable management member 130 and into the channel portion of the second opening 132. Side opening 131-1 and 132-1 may be designed and sized to allow for the cable portion 120 sliding through the respective opening (e.g., first opening 131 and/or second opening 132) to be taken out of the cable management member 130.

In terms of size, the side opening 131-1 may be an opening having a cross-sectional size that is less than, or equal to, a cross-sectional size of the cable portion 120. Put another way, the size of side opening 131-1 is seen to be less than, or equal to, the corresponding size of the first opening 131. Similarly, the side opening 132-1 may be an opening having a cross-sectional size that is less than, or equal to, a cross-sectional size of the cable portion 120. Put another way, the size of side opening 132-1 is seen to be less than, or equal to, the corresponding size of the second opening 132. Having side openings 131-1 and 132-1 that are sized less than, or equal to, the cable portion 120 size (i.e., the size of the first opening 131 and second opening 132) ensures that the cable portion 120 remains within the cable management member 130. However, due to the flexible characteristic of the cable management member 130, the cable portion 120 may still be withdrawn from the cable management member 130 by contorting, compressing, and/or manipulating the shape of the cable management member 130 to allow the cable portion 120 to be freed. The flexible characteristic of the cable management member 130 would also allow for the cable portion 120 to later be re-inserted into the first opening 131 or second opening 132 via the side opening 131-1 or side opening 132-1 by contorting, compressing, and/or otherwise manipulating the shape of the cable management member 130.

Although not specifically illustrated, in some embodiments the cable management member 130 may not include side openings 131-1 and 132-1, such that the cable portion 120 may not be removed from the cable management member 130.

FIG. 4 illustrates a front perspective view, side perspective view, a back perspective view, a bottom perspective view, and a cross-sectional view of the cable management member 130. The various perspective views provide additional perspective views for describing the cable management member 130 and the flat-shaped cable portion 120.

With reference to the cross-sectional view of the cable management member 130, the cross-sectional view is taken with respect to the sectional line 4 taken through the middle of the cable management member 130.

The cable management member 130 is described to be in a circular, or substantially circular, shape. For example, the cable management member 130 may be configured in a circular shape having a diameter of 10.5 mm. In addition, the cable management member 130 may be made of a polymer material that allows the cable portion 120 to slide through it, yet provide frictional hold due to contact friction between the cable management member 130 in contact with the cable portion 120 and the cable portion 120. For example, the cable management member 130 may be made of a thermoplastic polyurethane (TPU) polymer. In other embodiments, the cable management member 130 may be made of a same material as the cable portion 120.

Although the cable management member 130 is illustrated and described in this disclosure to be in a circular shape, it is within the scope of the innovation described by this disclosure for the cable management member 130 to be in a rectangular, square, oval, triangular, trapezoidal, diamond, or any other designable shape that may allow for at least the inclusion of the first opening 131 and the second opening 132 for receiving the cable portion 120.

This disclosure has described the cable portion 120 has having, for example, a shape having at least two flat opposing sides. This shape may correspond to a cross-sectional view along a length of the cable portion 120 to be two halves of a rectangular, or substantially rectangular, member. In particular, at least the cable portion 120 described as traveling through the cable management member 130 was described as having this shape.

However, it is within the scope of the innovation described by this disclosure for the cable management member 130 to be functional with the cable portion 120 having different cross-sectional shapes. For example, in some embodiments the cable portion 120 may have a circular cross-section throughout a length of the cable portion 120. In some embodiments, the cable portion 120 may have a triangular cross-section throughout a length of the cable portion 120. In some embodiments, the cable portion 120 may have a rectangular cross-section throughout a length of the cable portion 120. In some embodiments, the cable portion 120 may have an oval cross-section throughout a length of the cable portion 120. In some embodiments, the cable portion 120 may, have a trapezoidal cross-section throughout a length of the cable portion 120. In some embodiments, the cable portion 120 may have a diamond cross-section throughout a length of the cable portion 120. In other embodiments, the cable portion 120 may have any additional shape that may be formed with the materials described, and having the wires within the cable portion 120 to transmit the data.

It follows that for each embodiment utilizing a different shaped cable portion 120, the cable management member 130 will be modified for receiving the particular shape of the cable portion 120 in that embodiment. For example, for embodiments where the cable portion 120 has a circular cross-section, the first opening 131 may be configured to receive this cable portion 120 by being comprised of a circular top opening, circular channel, and circular bottom opening. The second opening 132 may similarly be configured to receive this cable portion 120 by being comprised of a circular top opening, circular channel, and circular bottom opening.

For embodiments where the cable portion 120 has a triangular cross-section, the first opening 131 may be configured to receive this cable portion 120 by being comprised of a triangular top opening, triangular channel, and triangular bottom opening. The second opening 132 may similarly be configured to receive this cable portion 120 by being comprised of a triangular top opening, triangular channel, and triangular bottom opening.

For embodiments where the cable portion 120 has a rectangular cross-section, the first opening 131 may be configured to receive this cable portion 120 by being comprised of a rectangular top opening, rectangular channel, and rectangular bottom opening. The second opening 132 may similarly be configured to receive this cable portion 120 by being comprised of a rectangular top opening, rectangular channel, and rectangular bottom opening.

For embodiments where the cable portion 120 has an oval cross-section, the first opening 131 may be configured to receive this cable portion 120 by being comprised of an oval top opening, an oval channel, and an oval bottom opening. The second opening 132 may similarly be configured to receive this cable portion 120 by being comprised of an oval top opening, an oval channel, and an oval bottom opening.

For embodiments where the cable portion 120 has a trapezoidal cross-section, the first opening 131 may be configured to receive this cable portion 120 by being comprised of a trapezoidal top opening, trapezoidal channel, and trapezoidal bottom opening. The second opening 132 may similarly be configured to receive this cable portion 120 by being comprised of a trapezoidal top opening, trapezoidal channel, and trapezoidal bottom opening.

For embodiments where the cable portion 120 has a diamond cross-section, the first opening 131 may be configured to receive this cable portion 120 by being comprised of a diamond top opening, diamond channel, and diamond bottom opening. The second opening 132 may similarly be configured to receive this cable portion 120 by being comprised of a diamond top opening, diamond channel, and diamond bottom opening.

For embodiments where the cable portion 120 is shaped in a different cross-sectional shape not specifically mentioned, the first opening 131 and second opening 132 of the cable management member 130 may be shaped to match the shape of the cable portion 120 in order to effectively receive the cable portion 120 through it.

The different shapes for the cable portion 120 and the corresponding shapes for the first opening 131 and second opening 132 of the cable management member 130 are provided for exemplary purposes only, as other shapes are also within the scope of this disclosure.

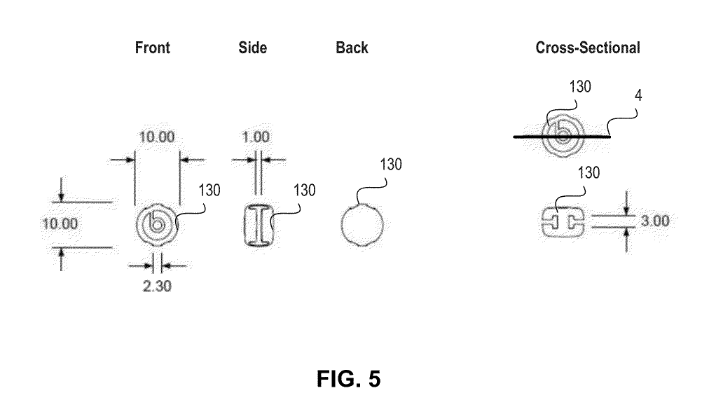

FIG. 5 illustrates an exemplary front perspective view of the cable management member, an exemplary side perspective view of the cable management member, an exemplary back perspective view of the cable management member, and an exemplary cross-sectional view of the cable management member that further identifies exemplary proportional size ratios for features of the cable management member.

For example, FIG. 5 illustrates that the proportional size ratio between a diameter, a side opening (e.g., side opening 131-1 or 132-1), a first and/or second opening (e.g., first opening 131 and/or second opening 132), and a space between first opening (e.g., first opening 131) and second opening (e.g., second opening 132) of the cable management member 130 may be 10:1:3:2.3 (e.g., 10 to 1 to 3 to 2.3) respectively. In other words, the size ratio of the diameter to the side opening of the cable management member 130 illustrated in FIG. 5 may be 10:1. The size ratio of the diameter to the first and/or second opening of the cable management member 130 illustrated in FIG. 5 may be 10:3. The size ratio of the diameter to the space between the first opening and the second opening of the cable management member 130 illustrated in FIG. 5 may be 10:2.3. The size ratio of the side opening to the first and/or second opening of the cable management member 130 illustrated in FIG. 5 may be 1:3. The size ratio of the side opening to the space between the first opening and the second opening of the cable management member 130 illustrated in FIG. 5 may be 1:2.3. The size ratio of the first and/or second opening to the space between the first opening and the second opening of the cable management member 130 illustrated in FIG. 5 may be 3:2.3.

The exemplary size ratios described above may correspond to a measurement standard such as mm, cm, inches, or other identifiable measurement standard. For example, the size for the diameter, the side opening (e.g., side opening 131-1 or 132-1), the first and/or second opening (e.g., first opening 131 and/or second opening 132), and the space between first opening (e.g., first opening 131) and second opening (e.g., second opening 132) of the cable management member 130 may be (10 mm):(1 mm):(3 mm):(2.3 mm) respectively. Further, the exemplary size ratio provided above for the features of the cable management member 130 described above is provided for exemplary purposes only, as other size ratios are contemplated to be within the scope of the cable management member 130 disclosed and described herein. In addition, although the description of size ratios have been provided in terms of the circular embodiment of the cable management member 130 having a diameter, it is within the scope of the innovation described herein that the diameter is replace with another length or width measurement that spans across the cable management member 130 from a first edge to a second edge when the cable management member 130 is in another shape.

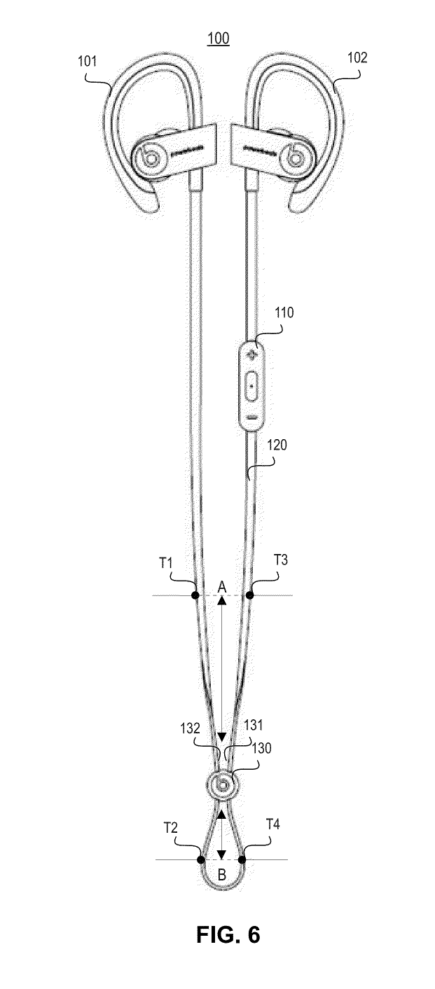

FIG. 6 illustrates the headphone system 100 having a specific track in which the cable management member 130 may be allowed to travel along the cable portion 120. The track may be comprised of a first section of the cable portion 120 from point T1 to T2, and a second section of the cable portion 120 from point T3 to T4. In some embodiments T2 and T4 may be eliminated such that the track is comprised of a single length of the cable portion 120 from T1 to T3. In any case, the track serves to restrict the movement of the cable management member 130 up towards direction (A) to a plane corresponding to points T1 and T3. The track may also serve to restrict the movement of the cable management member 130 down towards direction (B) to a plane corresponding to points T2 and T3, or in the embodiments where T2 and T4 are eliminated, the cable management member 130 may be restricted to movement to the end of the track section of the cable portion 120.

In some embodiments, a stopper member may be placed at one or more of the point locations corresponding to T1, T2, T3, or T4 in order to restrict the cable management member 130 from moving past such points on the cable portion 120.

In some embodiments, the length of the cable portion 120 that comprises the track section may have one of the cable portion shapes described herein, while the remaining length of the cable portion 120 that does not comprise the track section may have one of the other cable portion shapes described herein. In such embodiments, the cable management member 130 may then have a first opening 131 and second opening 132 that match the shape of the cable portion 120 that comprises the track section. In this way, the cable management member 130 may have its movement restricted to the track section of the cable portion 120.

In some embodiments, a combination of stopper members at one or more of the point locations corresponding to T1, T2, T3, or T4 and the cable portion 120/cable management member 130 shape matching feature described above may be utilized to achieve the restriction of the cable management member 130 to the track section of the cable portion 120.

It should be emphasized that the above-described embodiments, particularly, any “preferred” embodiments, are possible examples of implementations, merely set forth for a clear understanding of the principles of the invention. Many variations and modifications may be made to the above-described embodiment(s) without substantially departing from the spirit and principles of the techniques described herein. All such modifications are intended to be included herein within the scope of this disclosure and protected by the following claims.

1. A cable management member, comprising:
a first opening for receiving a first cable portion;
a second opening for receiving a second cable portion;
a first side opening that opens up around a portion of a periphery of the cable management member, and
a second side opening that opens up around a portion of a periphery of the cable management member opposite the first side opening.

2. The cable management member of claim 1, wherein the cable management member is made from a flexible material such that the cable management member is compressible to allow for the cable management member to contact the received first cable portion or received second cable portion.

3. The cable management member of claim 2, wherein the flexible material is a thermoplastic polyurethane.

4. The cable management member of claim 1, wherein the first opening comprises a top opening, a bottom opening, and a channel running from the top opening to the bottom opening of the first opening, and
wherein the second opening comprises a top opening, a bottom opening, and a channel running from the top opening to the bottom opening of the second opening.

5. The cable management member of claim 4, wherein the first side opening extends from the top opening to the bottom opening of the first opening, and
wherein the second side opening extends from the top opening to the bottom opening of the second opening.

6. The cable management member of claim 1, wherein the first cable portion and the second cable portion are part of a same cable wire.

7. The cable management member of claim 1, wherein the first cable portion and the second cable portion are configured to be comprised of at least two flat opposing sides.

8. The cable management member of claim 1, wherein the first side opening is smaller than the first cable portion, and the second side opening is smaller than the second cable portion.

9. The cable management member of claim 1, wherein the first opening and the second opening are shaped to receive the first cable portion and second cable portion, respectively.

10. The cable management member of claim 1, wherein the first cable portion and the second cable portion combined are less than a whole cable wire, and
wherein the first opening is configured to travel along the first cable portion and restricted from travel along the remainder of the whole cable wire, and the second opening is configured to travel along the second cable portion and restricted from travel along the remainder of the whole cable wire.

11. The cable management member of claim 1, wherein a size ratio between the first opening and the first side opening is 3 to 1, and a size ratio between the second opening and the second side opening is 3 to 1.

12. A headphone system, comprising:
an earpiece unit comprised of a first earpiece and a second earpiece, the earpiece unit further including a wireless interface configured to receive an audio data transmission;
a cable wire configured to connect the first earpiece and the second earpiece, and
a cable management member including a first opening for receiving a first cable portion of the cable wire, and a second opening for receiving a second cable portion of the cable wire.

13. The headphone system of claim 12, further comprising:
an input control portion configured to receive control commands for controlling at least a volume at which the audio data transmission is output from the earpiece unit.

14. The headphone system of claim 13, wherein the input control portion is attached to the cable wire.

15. The headphone system of claim 12, wherein the cable wire includes at least two flat opposing sides.

16. The headphone system of claim 12, wherein the first opening and the second opening are shaped to receive the first cable portion and second cable portion, respectively.

17. The headphone system of claim 12, wherein the first opening comprises a top opening, a bottom opening, and a channel running from the top opening to the bottom opening of the first opening, and
wherein the second opening comprises a top opening, a bottom opening, and a channel running from the top opening to the bottom opening of the second opening.

18. The headphone system of claim 17, wherein the cable management member further comprises:
a first side opening that extends around a portion of a periphery of the cable management member from the top opening to the bottom opening of the first opening, and
a second side opening that extends around a portion of a periphery of the cable management member that is opposite the first side opening from the top opening to the bottom opening of the second opening.

19. The headphone system of claim 18, wherein the first side opening is smaller than the first cable portion, and the second side opening is smaller than the second cable portion.

20. The headphone system of claim 18, wherein a size ratio between the first opening and the first side opening is 3 to 1, and a size ratio between the second opening and the second side opening is 3 to 1.

21. The headphone system of claim 12, wherein the cable management member is made from a flexible thermoplastic polyurethane material.

22. The headphone system of claim 12, wherein the first cable portion and the second cable portion combined are less than the entire length of the cable wire, and
wherein the first opening is configured to travel along the first cable portion and restricted from travel along the remainder of the cable wire, and the second opening is configured to travel along the second cable portion and restricted from travel along the remainder of the cable wire.
